(19) United States
(12) Patent Application Publication
(10) Pub. No.: US 2007/0275338 A1
(43) Pub. Date: Nov. 29, 2007

(54) METHOD AND APPARATUS FOR TRIMMING THE EDGES OF A FLOAT GLASS RIBBON

(75) Inventors: Stefan Acker, Waldeck (DE); Juergen Weisser, Jena (DE); Gabriele Eberhardt, Jena (DE); Ronny Ullmann, Kahla (DE); Vladimir Stepanovich Kondratenko, Moskau (RU)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: JENOPTIK Automatisierungstechnik GmbH

(21) Appl. No.: 11/751,756

(22) Filed: May 22, 2007

(30) Foreign Application Priority Data
May 23, 2006 (DE) 10 2006 024 825.2

(51) Int. Cl. F27B 9/28; F27D 3/00; F27D 21/00; F27D 19/00

(52) U.S. Cl. 432/8; 432/9; 432/32; 432/36

(57) ABSTRACT

A method and apparatus for trimming the edges of a float glass ribbon whose thickness can vary between 0.4 mm and 24 mm in which a specific depth crack is generated for the respective thickness. The depth of the crack is actively influenced by energy introduced by means of a laser which is controlled as a function of the surface temperature of the float glass ribbon and by a subsequent cooling whose acting period is variable. To ensure a permanently reliable process, the severing crack and the thickness of the float glass ribbon are detected in order to initiate a new initial crack immediately in the event that the severing crack should break up and so that a cutting unit comprising the scribing device, the beam-shaping optics and the cooling nozzles is always at a constant vertical distance from the surface of the float glass ribbon. The method and apparatus are distinguished particularly by the fact that only a low laser power is required.

### CROSS-REFERENCE TO RELATED APPLICATION

This application claims priority of German Application No. 10 2006 024 825.2, filed May 23, 2006, the complete disclosure of which is hereby incorporated by reference.

### BACKGROUND OF THE INVENTION

a) Field of the Invention

This invention is directed to a method and apparatus for trimming the edges of a float glass ribbon.

b) Description of the Related Art

U.S. Pat. No. 5,609,284 is one of the first patents to be published in which specific consideration is given to the correlation of process parameters with regard to a method for severing brittle flat material, particularly glass, by means of generating thermally induced stresses which lead to a crack of a specific depth.

A CO₂ laser (wavelength 10.6 μm) which is favorably absorbed by glass is preferably used in the method described in the above-cited patent. The parameters that are mentioned as having an influence on the crack depth δ which is crucial for the quality of the severed edge are the geometric size of the elliptical beam spot generated on the surface defined by the lengths of the secondary axis (width) a and the principal axis (length) b, the distance L between the laser beam and the subsequent coolant jet, the forward feed speed v, and the proportionality factor k which depends on the thermophysical properties of the material and the radiation output density. Based on the formula v=k·a·(b+L)/δ, the beam parameters a, b are selected with reference to the distance L and the forward feed speed v in such a way that a blind crack is formed with a required crack depth δ.

In the description of the prior art in WO 2005/092806, it is stated with reference to U.S. Pat. No. 5,609,284 that only glass thicknesses between 1.2 mm and 6 mm can be cut with the method described therein at a maximum attainable cutting speed of 1 m/min. In fact, only these values are supported by the embodiment examples.

The Applicant of WO 2005/092806 concludes from this that a method according to U.S. Pat. No. 5,609,284 is not suitable for trimming float glass directly at the float glass installation.

The process of producing float glass (float process) will be briefly described in the following in order to show the special technical requirements in cutting float glass (edge trimming). The float process is a continuous process which generally runs uninterruptedly for more than 10 years before requiring repair of the float trough.

The glass melt which is in a pasty-liquid state at 1100° C. is guided continuously from one side into an elongated bath of liquid tin on which the glass, which is about two thirds lighter, floats and spreads out uniformly similar to an oil slick. The glass which is solidified at the cooler end of the bath, but which is still warm at 600° C., is progressively drawn off and then passes through an annealing oven in which it is cooled down.

The drawing speed at which the solid glass is drawn off from the half-liquid phase and the tonnage of the melting oven determine the thickness of the glass. That is, in order to draw a determined glass thickness, the glass must be drawn off at a determined speed which is substantially determined from the duration of the annealing process. The sides of the glass, which taper toward the edges, are cut off (edge trimming) behind the annealing oven while still in the float glass installation in order to fabricate the glass ribbon at a uniform width of constant thickness. By cutting is meant the generation of a crack and subsequent breaking along the crack. The thickness of the float glass ribbon to be cut can be changed in a deliberate manner along its length. Glass thicknesses from about 0.4 mm are made possible by the float process. The worldwide standard thicknesses of 2, 3, 4, 5, 6, 8, 10, 12, 15, 19 and 24 mm are usually produced. The drawing speed varies between 30 m/min and 2 m/min depending on the thickness.

A method and an apparatus for trimming a float glass ribbon are subject to the following requirements by reason of the process factors in the float process:
1. The method must be suitable for generating a specific depth crack for glasses ranging in thickness from 0.4 mm to 24 mm.
2. Cutting speeds equal to the given drawing speeds must be possible.
3. It must be ensured that the crack formation is carried out continuously because the drawing process is also carried out continuously.
4. It must be ensured that the specific crack depth depending on thickness is achieved continuously, also in the transition periods when converting to different material thicknesses and during changes in temperature so that the breaking along the crack can always be carried out with an unchanged breaking force for uniform material thicknesses.

In order to generate a severing crack it is crucial that a sharply localized tensile stress exceeding the critical breaking stress is generated along the desired severing line on the material surface. The crack depth depends on the depth to which tensile stresses above the critical breaking stress must be introduced into the material. In order to achieve a high-quality severing edge, the crack must have a minimum depth which depends on the thickness and which is approximately one tenth of this thickness.

To generate the required sharply localized tensile stress above the critical breaking stress, a correspondingly sharply localized, sufficiently high temperature gradient must be formed.

The temperature gradient is achieved through heating and subsequent cooling. As is already known from U.S. Pat. No. 5,609,284, heating can be generated not only by the action of a laser but advantageously also by combining a global preheating of the material with localized application by laser. However, preheating requires an additional expenditure of energy because the material must be heated in its entirety, although only a local heating along the desired severing crack acts to support the method.

Logically, the energy needing to be introduced by laser to heat the material to a determined depth in proportion to the thickness is smaller due to the preheating.

In the method shown in U.S. Pat. No. 5,609,284, it does not appear possible, in spite of preheating, to introduce the required energy per surface element to generate the required tensile stresses at the required high speeds, which are codetermining for the acting time of the radiation per surface element, and taking into account material-specific maximum values for the radiation output density (to avoid melting at the surface) and the beam spot length which is indicated as advantageous.

WO 2005/092806 gives the impression that because of the high cutting rate this required high energy input is only possible by increasing the radiation output. However, this increased radiation output cannot be continuous because melting could occur. Therefore, it is proposed to apply laser radiation to the surface elements along a severing line continuously instead of once for a determined period of time, and to repeat this at appropriate intervals. In this way, the extreme rise in the surface temperature is prevented by allowing more time for the heat to be conducted into the interior of the material.

For this purpose, laser outputs of 400 to 600 W, scan speeds of 8 to 16 m/s, a beam spot diameter of 3.7 to 4.7 mm, and scan lengths of 160 to 500 mm are indicated in the embodiment example.

Process costs must be kept as low as possible particularly in a permanently running, continuous process. However, in the method described in WO 2005/092806 a multiple of the laser output is required compared to U.S. Pat. No. 5,609,284. In addition to this, there is the energy requirement for drawing the scanner.

### OBJECT AND SUMMARY OF THE INVENTION

It is the primary object of the invention to provide a method and an apparatus by which the edge of the float glass ribbon can be cut directly at a float glass installation by means of a laser with lower output. The thickness of the float glass ribbon can be changed between 0.4 and 24 mm.

It is another object of the invention to provide a method and an apparatus by which a permanent, continuous process can be ensured.

This object is met for a method in accordance with the invention for severing two portions of a body comprising the steps of forming a depth crack with a specific depth for the thickness of the body starting from an initial crack, the depth crack extending into the body from the surface of the body and in a desired direction along the surface; guiding an elliptical laser beam bundle to the surface along the desired direction at a cutting speed; directing a stream of coolant to an area of the surface that is heated by the beam bundle at a selected distance from the beam bundle; providing that the body of glass is a float glass ribbon whose core is still warm and whose surface temperature is between 50° C. and 80° C. and which is drawn in a float glass installation at a specific drawing speed for generating specific glass thicknesses in the range of 0.4 mm to 24 mm so that the cutting speed is identical to the drawing speed and the drawing direction is identical to the desired cutting direction; measuring the surface temperature of the float glass ribbon and forming the specific depth of the crack exclusively by controlling the laser output depending on the measured surface temperature; and measuring the thickness of the material and using the thickness as a regulated variable to keep the radiation ratios and cooling ratios constant over changes in thickness.

Further, the object is met in accordance with the invention by an apparatus for generating a specific depth crack induced by thermal stress in a float glass ribbon which is moved relative to the apparatus in the cutting direction which comprises a laser which is directed to the surface of the float glass ribbon; a cutting unit which comprises beam-shaping optics arranged downstream of the laser, a cooling device and a scribing device; a control device by which the output of the laser is controlled; a temperature sensor which is connected to the control device and which measures the surface temperature of the float glass ribbon in front of the location where the laser beam impinges on the float glass ribbon and supplies this surface temperature to the control device as a control quantity; the cooling device comprising a plurality of cooling nozzles which are arranged one behind the other in a straight line and which can be opened in a variable manner to be able to change the acting period of the coolant; and a thickness sensor being provided which detects the thickness of the float glass ribbon and supplies it to a regulating device as a controlled variable in order to adjust a constant vertical distance of the cutting unit relative to the float glass ribbon.

The invention is generally based on a method according to U.S. Pat. No. 5,609,284 and modifies the latter by two different mutually influencing steps to enable cutting of float glass ribbons with lower-power lasers.

It is beneficial for the solution to the stated object that the float glass ribbon is still at a temperature between approximately 50° C. and 80° C. during the scribing. In contrast to a preheated glass, float glass is warm-core, i.e., it drops in temperature from the inside to the outside, and consequently has tensile stresses at the surface and compressive stresses in the interior, which acts to reinforce the process.

The two steps for minimizing the radiation output requirement independent from the respective thickness involve an output control depending on the temperature of the float glass ribbon immediately prior to the action of the laser and an expanded period of heat removal.

For this purpose, an apparatus according to the invention has a temperature sensor, in particular an IR sensor, with which the surface temperature at the cutting location is measured and a plurality of cooling nozzles arranged one behind the other which make it possible to expand the cooling period compared to solutions with only one nozzle.

To ensure control of the process, a crack detector is provided which permanently detects the crack in order to initiate a new initial crack in the event that the crack should break up. The crack detector advantageously detects not only the presence of the crack but also its depth.

A thickness sensor detects the thickness of the material to maintain a constant distance of the scribing device, cooling nozzles and beam-shaping optics in relation to the material surface in case of changes in thickness so that, in particular, the cooling conditions and the beam spot size remain stable.

A special feature in edge trimming a float glass ribbon consists in that process parameters which are substantially codetermining for the cutting process are predetermined by the float process. For example, apart from the glass thickness which is given in any case, the cutting speed and the temperature of the material are also given for the cutting process.

As is indicated in U.S. Pat. No. 5,609,284, it is known from the prior art that the cutting speed is inversely proportional to the square of the thickness of the material, all other process parameters remaining constant. Interestingly, the interdependence between the thickness of the material and the drawing speeds customary in this connection is sufficiently similar in float glass production with the surprising result that a changing thickness of the material in connection with the changing drawing speed and, therefore, cutting speed need not be taken into account actively for the process control given a sufficiently large process window. The sufficiently large process window in relation to the lengths for the beam spot mentioned in the embodiment examples in U.S. Pat. No. 5,609,284 is achieved by increasing the beam spot length approximately tenfold. This beam spot length can be retained for all thicknesses. This means that only the laser output is regulated as a function of temperature during the cutting process. The thickness of the material and the drawing speed and cutting speed need not be known for controlling the process.

However, the advantageous monitoring of thickness by a sensor serves exclusively for tracking the cooling nozzles and the beam-shaping optics so that they ultimately have a constant distance from the material surface.

The invention will be described more fully in the following with reference to a drawing showing an embodiment example.

### BRIEF DESCRIPTION OF THE DRAWING

FIG. 1 is a schematic drawing of an apparatus according to the invention.

### DESCRIPTION OF THE PREFERRED EMBODIMENTS

An apparatus according to the invention can basically be mounted at a bridge or a frame above the horizontal transporting device of a float glass installation. Two apparatuses which may share a temperature sensor 5 and a thickness sensor 6, as the case may be, are required to cut off both edges of a float glass ribbon 13 simultaneously.

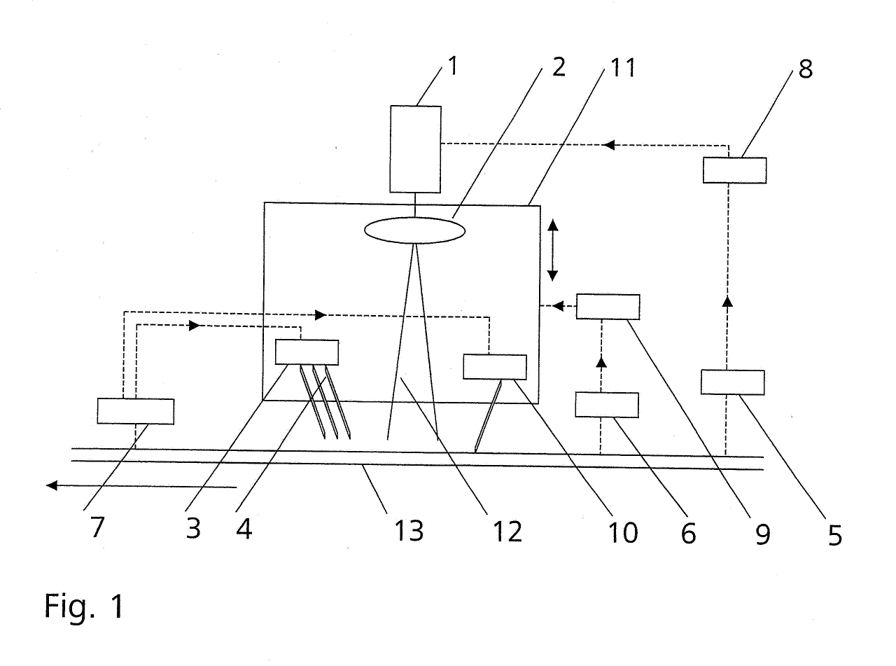

As is shown in FIG. 1, an apparatus according to the invention basically comprises a laser 1, beam-shaping optics 2 which are arranged downstream of the laser 1 and which shape the emitted laser beam bundle 12 into a beam bundle with an elliptical cross section, a cooling arrangement 3 with a plurality of cooling nozzles 4 arranged one behind the other in a straight line, a temperature sensor 5 which measures in a noncontacting manner, e.g., an IR sensor, a thickness sensor 6 which measures in a noncontacting manner, e.g., an ultrasonic sensor, a crack detector 7, a control device 8 by which the laser output is controlled as a function of the detected temperature, and a regulating device 9 which regulates the vertical position of a cutting unit 11 depending on thickness. The cutting unit 11 comprises the beam-shaping optics 2, the cooling arrangement 3 with cooling nozzles 4 and a scribing device 10.

By fastening the apparatus in a prescribed manner to a bridge or a frame 11 above the transporting belt, the cutting unit 11 and therefore in particular the beam-shaping optics 2, the cooling nozzles 4 and the scribing device 10 are positioned in a defined manner vertically and laterally with respect to the transporting device arranged horizontally below them. The scribing device 10, the beam-shaping optics 2 and the cooling nozzles 4 are arranged one behind the other at selected distances relative to one another in the transporting direction of the transporting device which is the same as the drawing direction of the float glass ribbon 13. Their vertical distance is regulated by the change in thickness so that they always maintain a constant distance from the float glass ribbon 13 moving on the transporting device regardless of the thickness of the float glass ribbon.

The cooling nozzles 4, three of which are provided in the embodiment example, can be opened individually or simultaneously so that the coolant can act locally over a shorter or longer period of time and the cooling penetrates to a varying depth from the surface into the material. The depth of the crack can also be influenced in this way, which is benefited by the fact that the material core is still warm.

The crack detector 7 is provided in order to ensure that a crack is always actually generated for the permanently and continuously running process. A radiation sensor which emits a measurement beam that is reflected back into the sensor at the interfaces of the crack can be used as a crack detector 7. When the distance and the angular position of the crack detector 7 to the crack is kept constant independent from the glass thickness, it is also possible to deduce the crack depth or changes in the crack depth by way of the intensity or change in intensity of the measurement beam reflected back into the crack detector 7. The crack detector 7 could be fastened to the horizontally fixedly arranged shaft of a loose vertically movable roller which rolls in the edge area on the surface of the float glass ribbon 13. In this way, it maintains a constant distance from the crack and always directs its measurement beam at the same angle to the interfaces of the crack.

As soon as a crack is no longer detected, a signal is sent to the scribing device 10 which immediately initiates a new initial crack. The crack detector 7 can also supply a signal when the crack depth is not sufficient. The crack is made deeper by switching on another cooling nozzle 4.

Instead of the optical crack detector 7, the existing crack could also be verified by once again sensing the temperature subsequent to cooling. With knowledge of the heating temperature determined by the surface temperature immediately before the action of the laser beam, the given energy input by the laser and the temperature measured following the cooling, the generated temperature gradient can be deduced and therefore also the occurring tensile stresses which have generated a crack insofar as they have exceeded the breaking stresses. For this purpose, a second temperature sensor would be arranged following the final cooling nozzle 4.

The cutting process starts when an initial crack is made on the surface of the float glass ribbon 13 which is transported relative to the apparatus in the cutting direction identical to the drawing direction at a cutting speed identical to the drawing speed depending on the actual thickness of the float glass ribbon 13. In the cutting direction, starting with the initial crack, a specific depth crack is made in the float glass ribbon 13 comparable to a method according to U.S. Pat. No. 5,609,284 in that the float glass ribbon 13 is initially acted upon along the desired path of the crack by a laser beam having an elliptical beam cross section and is subsequently cooled. The float glass ribbon 13 is subsequently broken in a known manner along the crack that has been formed in this way.

Contrary to the teaching of U.S. Pat. No. 5,609,284 to adapt the beam geometry corresponding to thickness, the beam spot geometry, particularly the beam spot length, remains constant regardless of the thickness. In practice, a beam spot length of 120 mm, which corresponds to approximately ten-times the beam spot lengths indicated in the embodiment examples in U.S. Pat. No. 5,609,284, has proven successful for all standard thicknesses of the float glass ribbon 13.

The laser output is controlled in the method according to the invention only as a function of temperature independent of the change in thickness which can have the range of a power of ten anyway. The range of variation of the temperature of the float glass ribbon 13 directly before the action of the laser is between approximately 50° C. and 80° C. The possible temperature differences result from the material-specific and thickness-specific regime of the active cooling in the annealing oven and the passive cooling through the plant temperature which can vary appreciably particularly over the course of a year.

A laser with an output of 200 W is sufficient for an apparatus which can process the full spectrum of conventional float glass thicknesses. For float glass installations provided only for producing glass of smaller thickness, e.g., only up to 6 mm, a laser with a maximum output of 100 W would even be sufficient.

It will be apparent to a person skilled in the art that the invention is not limited to the particulars of the embodiment forms discussed above by way of example, but that the present invention can be embodied in other specific forms without departing from the scope of the invention as set forth in the appended claims.

### REFERENCE NUMBERS

1 laser
2 beam-shaping optics
3 cooling arrangement
4 cooling nozzle
5 temperature sensor
6 thickness sensor
7 crack detector
8 control device
9 regulating device
10 scribing device
11 cutting unit
12 laser beam bundle
13 float glass ribbon

What is claimed is:

1. A method for severing two portions of a body of glass comprising the steps of:
forming a depth crack with a specific depth for the thickness of the body starting from an initial crack, said depth crack extending into the body from the surface of the body and in a desired direction along the surface;
guiding an elliptical laser beam bundle to the surface along the desired direction at a cutting speed;
directing a stream of coolant to an area of the surface that is heated by the beam bundle at a selected distance from the beam bundle;
providing that the body of glass is a float glass ribbon whose core is still warm and whose surface temperature is between 50° C. and 80° C. and which is drawn in a float glass installation at a specific drawing speed for generating specific glass thicknesses in the range of 0.4 mm to 24 mm so that the cutting speed is identical to the drawing speed and the drawing direction is identical to the desired cutting direction;
measuring the surface temperature of the float glass ribbon and joining the specific depth of the crack exclusively by controlling the laser output depending on the measured surface temperature; and
measuring the thickness of the material and using the thickness as a regulated variable to keep the radiation ratios and cooling ratios constant over changes in thickness.

2. The method according to claim 1, wherein the area acted upon by the stream of coolant is elongated in the cutting direction to bring about a heat extraction at greater depths.

3. The method according to claim 2, wherein the length of the area acted upon by the coolant can be varied in that the cooling nozzles which are arranged one behind the other are switched on and off.

4. The method according to claim 1, wherein the formation of the crack is detected optically so that in the event that the crack breaks open a new initial crack is made.

5. The method according to claim 4, wherein, when the crack is detected, the crack depth is also detected in order to lengthen the area acted upon by the stream of coolant when the crack depth is too shallow.

6. The method according to claim 1, wherein a laser of 200 W is used for generating the laser output.

7. The method according to claim 1, wherein the temperature is detected along the crack behind the cooled area in order to be able to deduce formation of a crack from this temperature in connection with the laser output and the measured temperature immediately before the impingement of the laser beam.

8. An apparatus for generating a specific depth crack induced by thermal stress in a float glass ribbon which is moved relative to the apparatus in the cutting direction, comprising:
a laser which is directed to the surface of the float glass ribbon;
a cutting unit which comprises beam-shaping optics arranged downstream of the laser, a cooling device and a scribing device;
a control device by which the output of the laser is controlled;
a temperature sensor which is connected to the control device and which measures the surface temperature of the float glass ribbon in front of the location where the laser beam impinges on the float glass ribbon and supplies this surface temperature to the control device as a control quantity;
said cooling device comprising a plurality of cooling nozzles which are arranged one behind the other in a straight line and which can be opened in a variable manner to be able to change the acting period of the coolant;
a thickness sensor being provided which detects the thickness of the float glass ribbon and supplies it to a regulating device as a controlled variable in order to adjust a constant vertical distance of the cutting unit relative to the float glass ribbon; and
a crack detector which communicates with the scribing device in order to initiate a new initial crack in the event that the crack should break up.

9. The apparatus according to claim 8, wherein the crack detector is also connected to the cooling device so that the individual cooling nozzles are opened depending on the crack depth that is reached.
